(19) United States
(12) Patent Application Publication
(10) Pub. No.: US 2011/0105162 A1
(43) Pub. Date: May 5, 2011

(54) APPARATUS AND METHOD FOR TRANSMITTING AND RECEIVING CONTROL INFORMATION IN WIRELESS COMMUNICATION SYSTEM

(75) Inventors: Kitae Kim, Suwon-si (KR); Kibum Kwon, Ansan-si (KR)

(73) Assignee: PANTECH CO., LTD., Seoul (KR)

(21) Appl. No.: 12/938,824

(22) Filed: Nov. 3, 2010

(30) Foreign Application Priority Data
Nov. 5, 2009 (KR) 10-2009-0106675

(51) Int. Cl. H04W 40/00

(52) U.S. Cl. 455/500

(57) ABSTRACT

A system and a method for transmitting control information by a system in a heterogeneous wireless communication network using Component Carriers (CCs), the heterogeneous wireless communication network including a first wireless communication network and a second wireless communication network, which at least partially overlap and are heterogeneous, the system controlling the second wireless communication network can more stably and efficiently transmit control information in a heterogeneous network environment. The method includes: calculating an environmental parameter having an influence on transmission of control information; determining a transmission scheme of the control information according to the calculated environmental parameter; and transmitting the control information to a User Equipment (UE) connected to the second wireless communication network according to the determined transmission scheme.

### CROSS-REFERENCE TO RELATED APPLICATION

This application claims priority from and the benefit under 35 U.S.C. §119(a) of Korean Patent Application No. 10-2009-0106675, filed on Nov. 5, 2009, which is hereby incorporated by reference for all purposes as if fully set forth herein.

### BACKGROUND

1. Field

Embodiments of the present invention relate to an apparatus, a system, and a method for transmitting and receiving control information in a wireless communication system.

2. Discussion of the Background

In a wireless communication network environment that integrates heterogeneous is communication systems, it is efficient to transmit a large quantity of information while reducing the signal interference between heterogeneous wireless communication systems.

As different types of wireless communication network nodes have various magnitudes of power and various types of service coverage, it is inefficient to previously establish settings for the transmission of control information in such a network system.

Meanwhile, in a scheme of newly establishing settings for the transmission of control information according to a wireless communication network environment, it may be difficult to make an interactive control between heterogeneous wireless communication systems, which prevents an improvement in the control information transmission efficiency in a wireless communication system.

### SUMMARY

Exemplary embodiments of the present invention provide a method, an apparatus, and a system for transmitting and receiving downlink control information in a wireless communication system.

Exemplary embodiments of the present invention provide a method, an apparatus, and a system for repeatedly transmitting and receiving downlink control information in a wireless communication system.

Exemplary embodiments of the present invention provide a method, an apparatus, and a system for transmitting and receiving downlink control information while controlling a data rate of the control information in a wireless communication system.

Exemplary embodiments of the present invention provide a method, an apparatus, and a system for determining the number of times for repetition of a control information element in order to transmit and receive downlink control information in consideration of a service coverage of a cell in a wireless communication system.

Exemplary embodiments of the present invention provide a method, an apparatus, and a system, by which network nodes having a relatively low Radio Frequency (RF) coverage can more stably and efficiently transmit control information in a network environment.

Exemplary embodiments of the present invention provide a method, an apparatus, and a system, which can improve the accuracy of control information in consideration of elements having an influence on the formation of a service coverage of a network node in a network system.

Exemplary embodiments of the present invention provide a method, an apparatus, and a system for transmitting control information while reducing interference between network nodes in a network system.

Additional features of the invention will be set forth in the description which follows, and in part will be apparent from the description, or may be learned by practice of the invention.

An exemplary embodiment of the present invention provides a method for transmitting control information by a system in a wireless communication network using Component Carriers (CCs), the wireless communication network including a first wireless communication network node and a second wireless communication network node, which at least partially overlap with each other, the system controlling the second wireless communication network node, the method including: calculating an environmental parameter having an influence on transmission of control information; determining a transmission scheme of the control information according to the calculated environmental parameter; and transmitting the determined transmission scheme and the control information to a User Equipment (UE) connected to the second wireless communication network node according to the determined transmission scheme.

An exemplary embodiment of the present invention provides a system to transmit control information in a wireless communication network using Component Carriers (CCs), the wireless communication network including a first wireless communication network node and a second wireless communication network node, which at least partially overlap with each other, the system controlling the second wireless communication network node, the system including: an environmental parameter calculation unit to calculate an environmental parameter having an influence on transmission of control information; a transmission scheme determination unit to determine a transmission scheme of the control information according to the calculated environmental parameter; and a transmission unit to transmit the determined transmission scheme and the control information to a User Equipment (UE) connected to the second wireless communication network node according to the determined transmission scheme.

An exemplary embodiment of the present invention provides a method for receiving control information by a User Equipment (UE) in a wireless communication network using Component Carriers (CCs), the wireless communication network including a first wireless communication network node and a second wireless communication network node, which at least partially overlap with each other, the UE being connected to the second wireless communication network node, the method including: receiving information on a transmission scheme of control information determined according to an environmental parameter having an influence on transmission of the control information; and decoding the control information based on the received information.

An exemplary embodiment of the present invention provides a User Equipment (UE) to receive control information in a heterogeneous wireless communication network using Component Carriers (CCs), the heterogeneous wireless communication network including a first wireless communication network node and a second wireless communication network node, which at least partially overlap with each other, the UE being connected to the second wireless communication network node, the UE including: a receiving unit to receive information on a transmission scheme of control information determined according to an environmental parameter having an influence on transmission of the control information; and a decoding unit to decode the control information based on the received information.

An exemplary embodiment of the present invention provides a method for transmitting control information by a system in a wireless communication network using Component Carriers (CCs), the wireless communication network including a first wireless communication network node and a second wireless communication network node, which at least partially overlap with each other, the system controlling the second wireless communication network node, the method including: calculating an environmental parameter having an influence on transmission of control information; determining an aggregation level that corresponds to a number of contiguous Control Channel Elements (CCEs) according to the calculated environmental parameter; allocating the control information to one or more CCEs according to the aggregation level; and transmitting the allocated control information to a UE connected to the second wireless communication network node.

An exemplary embodiment of the present invention provides a system to transmit control information in a wireless communication network using Component Carriers (CCs), the wireless communication network including a first wireless communication network node and a second wireless communication network node, which at least partially overlap with each other, the system controlling the second wireless communication network node, the system including: an environmental parameter calculation unit to calculate an environmental parameter having an influence on transmission of control information; a transmission scheme determination unit to determine an aggregation level that corresponds to a number of contiguous Control Channel Elements (CCEs) according to the calculated environmental parameter; and a transmission unit to allocate the control information to one or more CCEs according to the aggregation level, and to transmit the allocated control information to a UE connected to the second wireless communication network node.

An exemplary embodiment of the present invention provides a method for receiving control information by a User Equipment (UE) in a wireless communication network using Component Carriers (CCs), the wireless communication network including a first wireless communication network node and a second wireless communication network node, which at least partially overlap with each other, the UE being connected to the second wireless communication network node, the method including: receiving information on an aggregation level that corresponds to a number of contiguous Control Channel Elements (CCEs) and has been determined according to an environmental parameter having an influence on transmission of control information; determining a valid search space according to the received information on the aggregation level and performing a blind decoding within the valid search space; and acquiring control information as a result of the blind decoding.

An exemplary embodiment of the present invention provides a User Equipment (UE) to control information in a wireless communication network using Component Carriers (CCs), the wireless communication network including a first wireless communication network node and a second wireless communication network node, which at least partially overlap with each other, the UE being connected to the second wireless communication network node, the UE including: a receiving unit to receive information on an aggregation level that corresponds to a number of contiguous CCEs and has been determined according to an environmental parameter having an influence on transmission of control information; a decoding unit to determine a valid search space according to the received information on the aggregation level, to perform a blind decoding within the valid search space, and to acquire control information as a result of the blind decoding.

An exemplary embodiment of the present invention provides a method for transmitting control information by a system in a heterogeneous wireless communication network using Component Carriers (CCs), the method including: calculating an environmental parameter having an influence on transmission of control information; determining a transmission scheme of the control information according to the calculated environmental parameter; and transmitting the control information according to the determined transmission scheme.

An exemplary embodiment of the present invention provides a method for receiving control information by a User Equipment (UE) in a wireless communication network using Component Carriers (CCs), the method including: receiving information on a transmission scheme of control information determined according to an environmental parameter having an influence on transmission of the control information; and decoding the control information based on the received information.

Exemplary embodiments of the present invention provide an efficient transmission of control information.

Exemplary embodiments of the present invention provide a network system including an LTE-A system that can achieve more efficient transmission of control information and can secure a stable PDCCH transmission region for each CC in the case of two or more CCs.

Exemplary embodiments of the present invention provide, since the repetitive transmission level for transmission of control information is determined in consideration of the characteristics of a UE connected to a network, increased reception reliability of the control information.

Exemplary embodiments of the present invention provide information to be transmitted according to the transmission scheme of control information to a UE and to reduce the number of times of blind decoding of the UE.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a wireless communication system according to an exemplary embodiment of the present invention.

FIG. 2 is a block diagram illustrating an uplink/downlink frequency structure in the case of using multiple CCs in a wireless communication system according to an exemplary embodiment of the present invention.

FIG. 3 is a block diagram illustrating transmission of control information through a plurality of CCs in a wireless communication system according to an exemplary embodiment of the present invention.

FIG. 4 illustrates a structure of a control signal in a wireless communication system according to an exemplary embodiment of the present invention is applicable.

FIG. 5 illustrates an aggregation level and a corresponding CCE construction in a wireless communication system according to an exemplary embodiment of the present invention.

FIG. 6 illustrates occurrence of an interference due to overlapping between control information regions in heterogeneous wireless communication systems according to an exemplary embodiment of the present invention.

FIG. 7 illustrates different settings for the transmission of control information in a femto cell according to an exemplary embodiment of the present invention.

FIG. 8 is a flowchart illustrating a method for deriving a CCE aggregation level for transmission of control information according to an exemplary embodiment of the present invention.

FIG. 9 is a block diagram illustrating a relation between elements for deriving a minimum CCE aggregation level in order to adjust settings of a transmission scheme of control information according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough, and will fully convey the scope of this disclosure to those skilled in the art. Various changes, modifications, and equivalents of the systems, apparatuses, and/or methods described herein will likely suggest themselves to those of ordinary skill in the art. Elements, features, and structures are denoted by the same reference numerals throughout the drawings and the detailed description, and the size and proportions of some elements may be exaggerated in the drawings for clarity and convenience.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

Further, when a feature is described as including “at least one of” A and B, A, B, or A and B may be included.

The following description is based on a wireless communication network, and works in the wireless communication network may be performed either in a process of controlling the network node and transmitting data by a system (e.g. base station) managing the wireless communication network or by a terminal connected to the wireless communication network.

Aspects of the present invention provide for an efficient transmission of control information according to an environment in a wireless communication network connected to a different wireless communication network node, and can be used in a plurality of wireless communication network nodes connected to a Long Term Evolution-Advanced (LTE-A) system.

The following description is based on a case in which wireless communication network nodes at least partially overlap or completely overlap with each other.

For a detailed description, an LTE-A network is discussed as an example of a wireless communication network node (macro cell) having a wide coverage.

A wireless communication network, an area of which may at least partially overlap with the LTE-A network area, include a micro cell network node, a pico cell network node, and a femto cell network node. For convenience of description, the femto cell network node is mainly discussed. However, aspects of the present invention are not limited to the LTE-A or femto cell network node and can be applied to any case in which wireless communication network nodes at least partially overlap with each other.

An LTE-A system can be applied to network nodes including nodes having various types of Radio Frequency (RF) coverage so as to increase cell coverage extension and spatial efficiency.

As an example of a configuration of network nodes, a micro/pico/femto cell and a relay node may be connected to an existing macro cell (broadband) network node.

Hereinafter, a femto cell according to an exemplary embodiment of the disclosure from the network system coupled to the broadband network node will be discussed.

In network system, a femto cell has a limited transmission power and thus has limited service coverage.

In more detail, a femto cell: (1) may have a limited transmission range for control information (Physical Downlink Control Channel; PDCCH) due to the limitation in the transmission power; (2) may be susceptible to an interference from neighbor cells (including macro base stations); and (3) may have an increased search space for the PDCCH due to addition of a Carrier Indicator (CI) to a Downlink Control Information (DCI) format in a Carrier Aggregation (CA) environment.

In relation to (3) above, the increased search space for the PDCCH, (i) the accuracy in reception of a PDCCH of a low Control Channel Element (CCE) Aggregation Level (AL) may be decreased due to the small transmission power from the base station, and (ii) a fast handover may be expected due to the limited service coverage, which may cause the influence of the blind decoding complexity of a PDCCH on a User Equipment (UE) to be larger than in the case of communication with a macro base station.

Various network elements (nodes) of a network system may have different types of service coverage according to the transmission power, electronic wave characteristics, and interference environment, and such an influence may be increased in a CA environment using a plurality of Component Carriers (CCs).

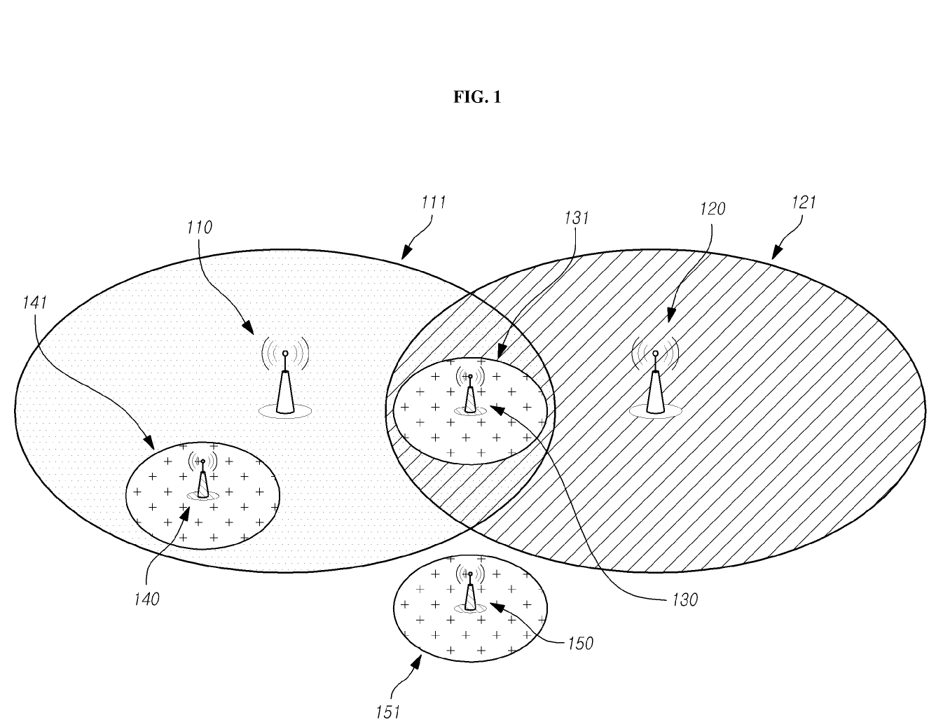

FIG. 1 is a block diagram illustrating a wireless communication system according to an exemplary embodiment of the present invention. Referring to FIG. 1, each of reference numerals 110 and 120 indicates an LTE-A system or macro cell, and reference numerals 111 and 121 indicate RF coverage of the systems 110 and 120, respectively. Also, reference numerals 130, 140, and 150 indicate network nodes (e.g. femto cells), which have various RF coverages 131, 141, and 151.

However, due to the limited transmission power of the network nodes 130, 140, and 150, the RF coverages 131, 141, and 151 of the network nodes 130, 140, and 150, such as femto cells, are smaller than those of typical macro cells 110 and 120.

The LTE-A system supports a CA mode allowing use of 4 CCs in addition to the frequency band allocated for the LTE system, and nodes, such as a node of a femto cell, also can use the CA mode.

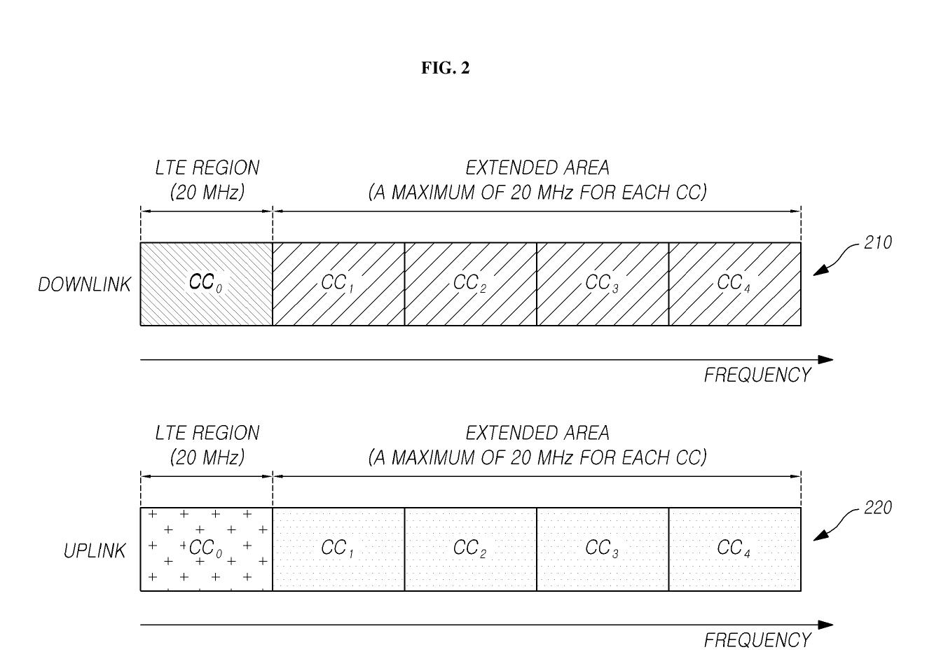

FIG. 2 is a block diagram illustrating an uplink/downlink frequency structure in the case of using multiple CCs in a wireless communication system according to an exemplary embodiment of the present invention. Referring to FIG. 2, reference numerals 210 and 220 indicate the downlink and the uplink, respectively, each of which includes a plurality of Component Carriers (CCs). In the LTE-A system, each CC has a bandwidth of a maximum of 20 MHz, and a maximum of five CCs may be applied to the downlink or the uplink. However, aspects of the present invention are not limited thereto such that characteristics of the CCs may be extended or changed according to the construction of the network or the construction of the LTE-A system.

Generally, in the LTE-A system, three types of CCs including a Backward Compatible (BC) carrier, a Non-Backward Compatible (NBC) carrier, and an extension carrier can be defined. CCs used in an LTE-A system include one of a BC carrier and an NBC carrier, and may include an extension carrier, which cannot stand alone, if necessary.

According an aspect of the present invention, even a femto cell having a narrow RF coverage can operate in the CA mode of the LTE-A and can additionally use a plurality of CCs according to the necessity. In the LTE-A, control information for each CC can be transmitted through a PDCCH, and transmission of a PDCCH through another CC is also possible.

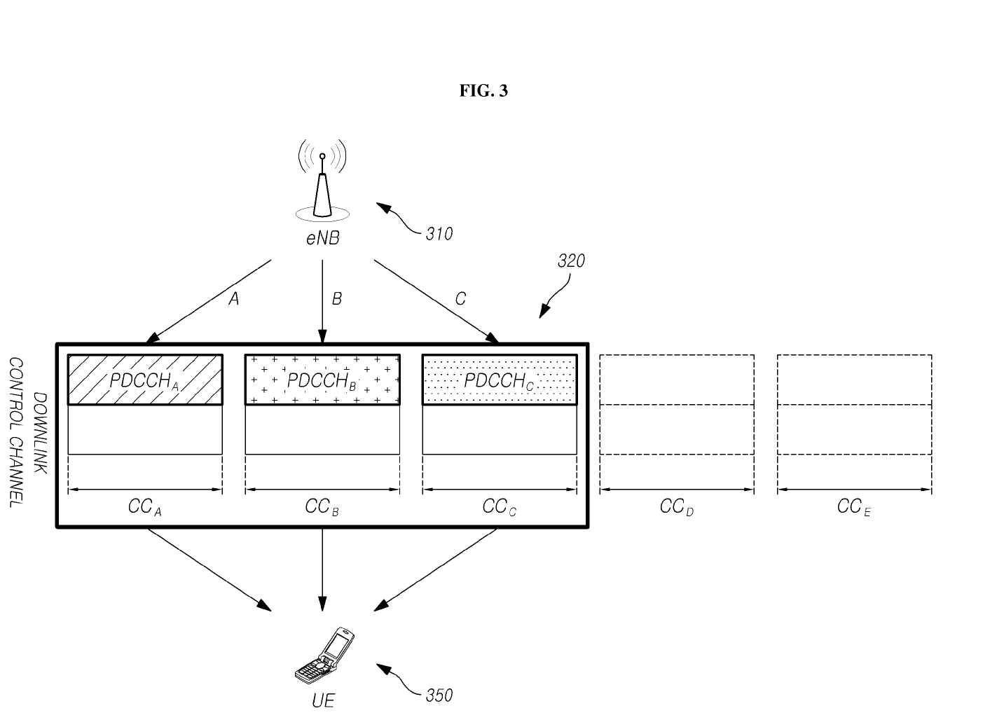

FIG. 3 is a block diagram illustrating transmission of control information through a plurality of CCs in a wireless communication system according to an exemplary embodiment of the present invention. Referring to FIG. 3, an LTE enhanced Node B (eNB) 310 transmits control information to a User Equipment (UE) 350 by using a Downlink Control Channel (DLCH) for controlling the downlink.

In FIG. 3, the eNB 310 uses three CCs including CC_{A}, CC_{B}, and CC_{C} as indicated by reference numeral 320, wherein CC_{A}, CC_{B}, and CC_{c} transmit PDCCHs including PDCCH_{A}, PDCCH_{B}, and PDCCH_{C}, respectively. However, aspects are not limited thereto such that it is possible to transmit PDCCHs by using more CCs (for example, CC_{D} and CC_{E}).

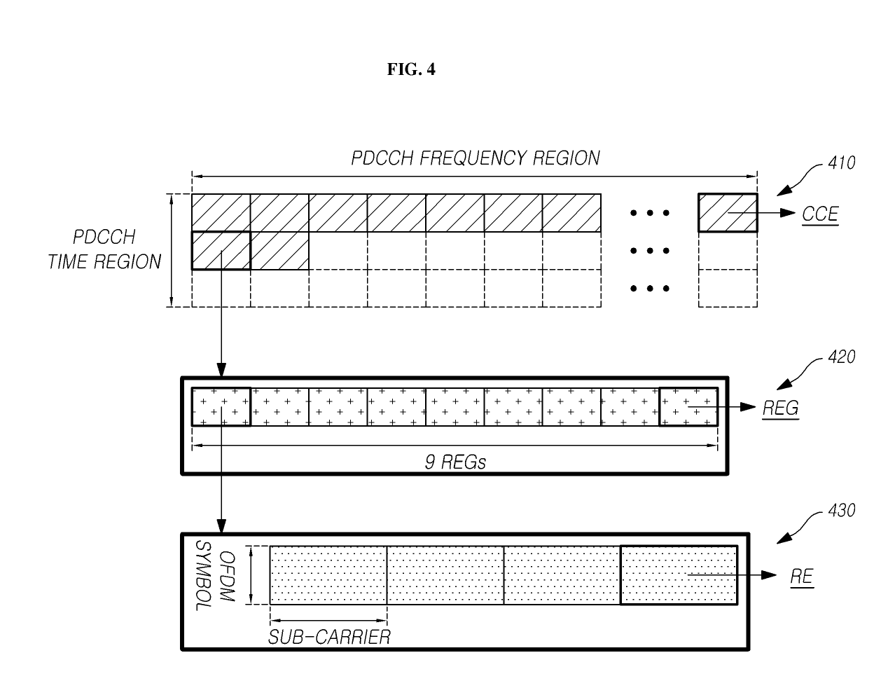

FIG. 4 illustrates a structure of a control signal in a wireless communication system according to an exemplary embodiment of the present invention.

Referring to FIG. 4, a PDCCH 410 includes a plurality of Control Channel Elements (CCEs). Downlink Control Information (DCI) may be mapped to the CCE for transmission.

Specifically, mapping of each DCI within a PDCCH is performed based on each CCE. For one CCE, an allocation space with a maximum of 72 bits (36 QPSK symbols) has been defined.

A total of 10 formats have been defined for the DCI, and the DCI is mapped to each CCE having a size of 72 bits within a PDCCH. This construction is based on the current construction of the LTE-A and may be changed in various ways in the future, and aspects of the present invention is not limited to the current construction.

One CCE includes 9 Resource Element Groups (REGs), and one REG usually includes 4 Resource Elements (REs) 430. One RE includes one sub-carrier and one Orthogonal Frequency Division Multiplexing (OFDM) symbol. That is, one CCE includes 36 REs. As a result, when an RE is coded according to a QPSK scheme, information of a maximum of 72 bits can be mapped since one RE corresponds to 2 bits.

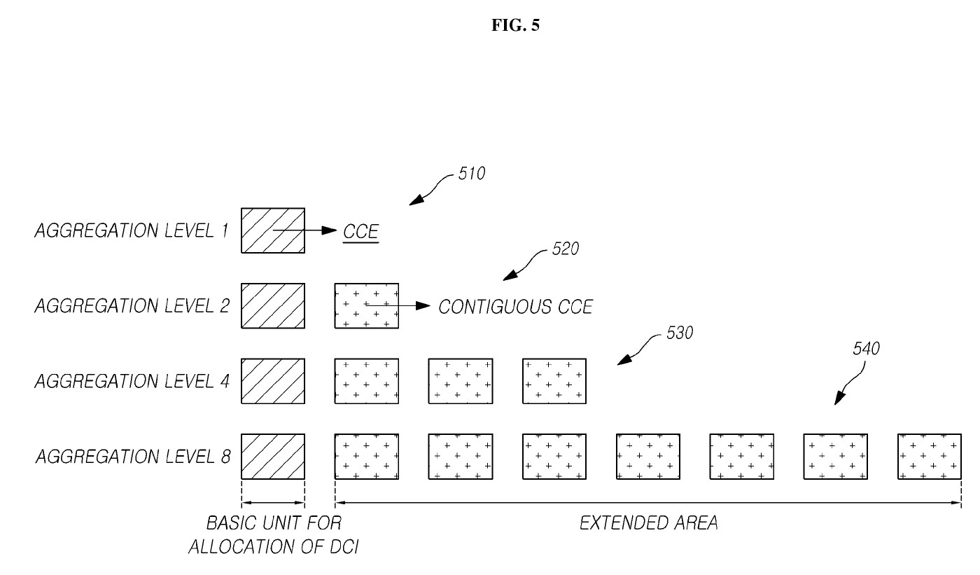

FIG. 5 illustrates an aggregation level and a corresponding CCE construction in a wireless communication system according to an exemplary embodiment of the present invention.

The reception accuracy for the PDCCH allows a Block Error Rate (BLER) of only 1% or less, and a maximum of 8 contiguous CCEs may be allocated and used in consideration of the reception accuracy of the PDCCH.

The number of CCEs consecutively used in order to map the DCI within the PDCCH is defined as a CCE aggregation level. When the channel condition is not good, the DCI mapping within the PDCCH is performed in a direction increasing the CCE aggregation level.

In FIG. 5, reference numerals 510, 520, 530, and 540 indicate aggregation levels 1, 2, 4, and 8, respectively.

Actual multiple CCE allocation for the DCI is achieved by repetition through a rate matching. Aggregation level 1 indicated by reference numeral 510 corresponds to the case of using one CCE, and aggregation level 2 indicated by reference numeral 520 corresponds to the case of using two CCEs. When the channel condition is not good, the aggregation level can be elevated from aggregation level 1 to aggregation level 8. Then, the number of transmitted CCEs increases from 1 to 8.

Now, a scheme for allocating a DCI in a control region (PDCCH region) will be described in more detail.

According to the format of the DCI, the number of generated information bits may be different. The information bits generated according to the DCI format are transmitted to the transmitter after being subjected to a channel-coding. For example, on an assumption that a ⅓ encoding is applied to the information bits, information bits having a length three times longer than the encoded information bits are generated. At this time, a tail bit convolution coding or other predetermined coding schemes may be applied to the ⅓ encoding.

For example, when 37 information bits have been generated for a predetermined DCI format, the information bits become 111 bits after the channel coding. Then, at the final processing operation, a matching block maps the encoded information bits, 72 bits by 72 bits, to the CCE. Therefore, 72 bits are allocated at aggregation level 1, 144 bits are allocated at aggregation level 2, 288 bits are allocated at aggregation level 4, and 576 bits are allocated at aggregation level 8. According to the elevation of the aggregation level, consecutive allocation of the information bits to the CCEs is performed in the form of cyclic shift. At this time, the number of repetitions in each interval may be different according to the length of the encoded information bits and the aggregation level.

As a result, according to the elevation of the aggregation level, the generated information bits are repeatedly mapped to the CCEs. Therefore, the more the CCEs are used, the higher the reliability of the PDCCH is.

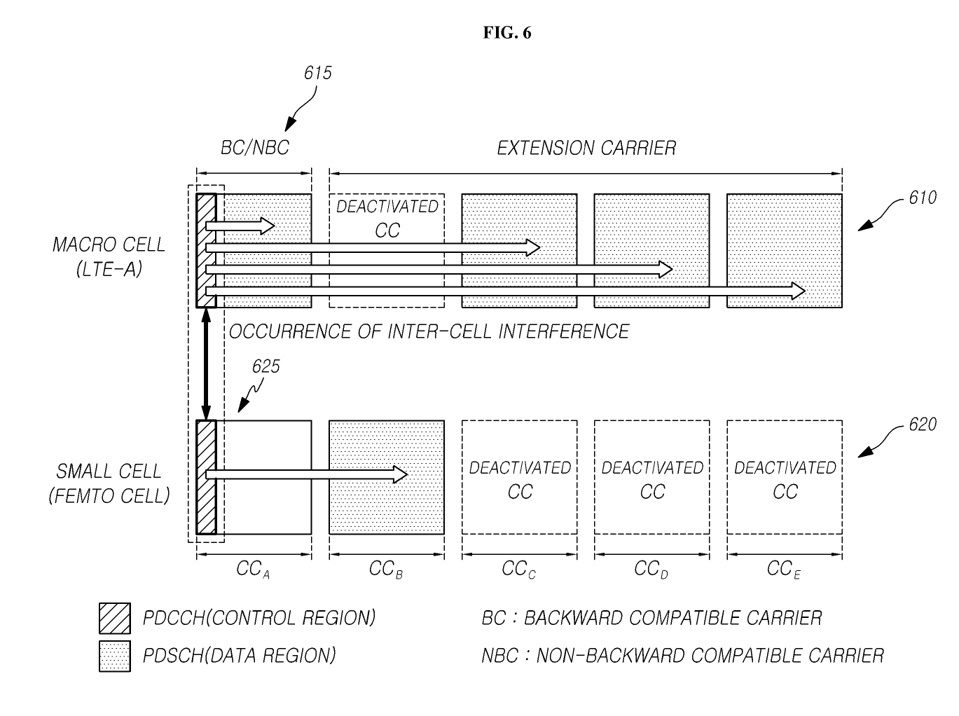

FIG. 6 illustrates occurrence of an interference due to overlapping between control information regions in heterogeneous wireless communication systems according to an exemplary embodiment of the present invention.

Referring to FIG. 6, the PDCCH corresponds to a channel for transmitting control information requiring an exact transmission to a UE within a given area regardless of an RF coverage of an eNB. However, in the case of a network system, such as a femto cell, since the eNB may have a limited transmission power, the accuracy of the transmitted control information may abruptly change according to the position of a UE. Therefore, when a macro cell, is combined with a femto cell, the following problems may occur.

(1) Since a femto eNB may use only a low power, the PDCCH is transmitted with a low power, which may decrease the accuracy in receiving the PDCCH by a UE. Therefore, it is probable that all transmitted DCIs have Aggregation Levels (ALs) above a predetermined level.

(2) In the CA environment, even nodes having narrow RF coverages may have different electronic wave characteristics according to the CC, which may have an influence on the transmission range of the PDCCH.

(3) Network nodes using a limited transmission power are susceptible to an interference from neighbor cells and thus may be largely influenced by the Inter-Cell Interference Coordination (ICIC). Therefore, there is a possibility that transmission of a DCI having a low CCE AL may fail.

(4) The transmission accuracy of the PDCCH may be degraded due to an overlapping of PDCCH regions for transmission of control information. In the CA environment, it is possible to transmit a PDCCH only through a BC or an NBC, and it is impossible to transmit a PDCCH through an extension carrier.

Therefore, as shown in FIG. 6, in relation to the Physical Downlink Shared Channel (PDSCH) actually transmitting data, the PDSCHs 610 in the macro cell may be arranged differently from the PDSCHs 620 in the small cell (femto cell). However, the PDCCH 615 in the macro cell and the PDCCH 625 in the macro cell may be located at the same position. Then, the PDCCHs may cause an interference between the macro cell and the femto cell. Further, the PDCCH region of the femto cell having a relatively lower transmission power is more susceptible to the inter-cell interference and thus has a lower transmission accuracy.

That is, when the network nodes (of micro/pico/femto cells having relatively narrow RF coverages) connected to the LTE-A system follows the conventional PDCCH transmission scheme of the existing LTE system, the transmission accuracy of the control information may be degraded and, sometimes, a UE may be unable to receive a PDCCH.

Exemplary embodiments of the present invention provide a scheme capable of improving the transmission accuracy by establishing different settings for the transmission of control information of network nodes, in order to achieve a more efficient transmission of control information in a network nodes in a system, such as in a combination of an LTE-A and a femto cell, as described above.

However, when uniformly establishing settings for the transmission of control information in advance in the system, it may be impossible to satisfy one of the network efficiency and the data rate. Therefore, an exemplary embodiment of the present invention provides a scheme of examining environmental elements of each network node and transmitting control information according to the transmission situation of the network node.

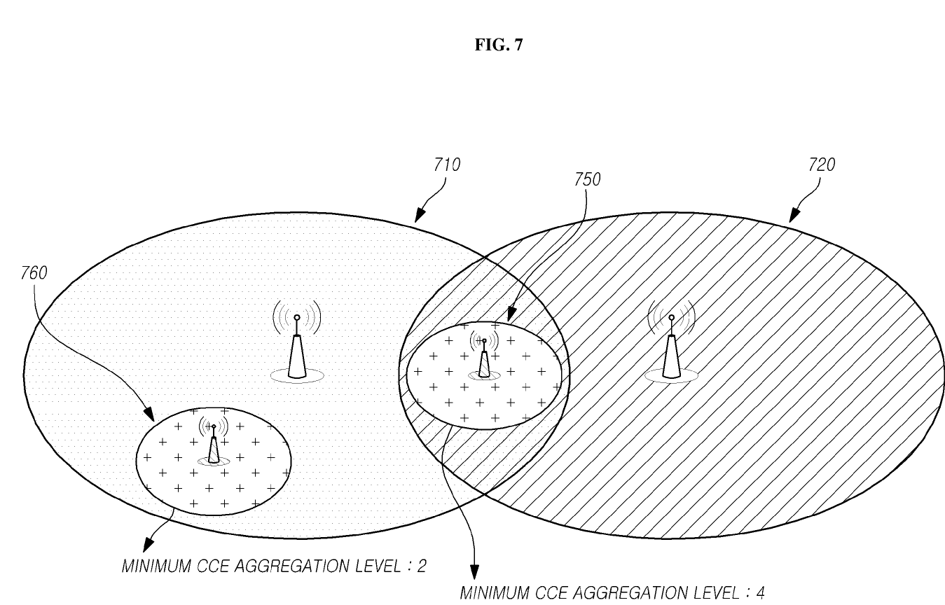

FIG. 7 illustrates different settings for the transmission of control information in a femto cell according to an exemplary embodiment of the present invention. According to an exemplary embodiment of the present invention, a first femto cell 750, which belongs to both RF coverages of two macro cells 710 and 720, that is, which is located within an overlapping area of the RF coverages of the two macro cells 710 and 720, has an RF coverage smaller than that of a second femto cell 760 belonging to only one macro cell 710. This is because there is a high possibility that the first femto cell 750 may be subjected to interferences (inter-cell interferences) from the two macro cells 710 and 720.

More specifically, even when each of the first and second femto cells 750 and 760 uses the same transmission power as the power of the surrounding macro cells 710 and 720, the actual service coverage of each of the femto cells 750 and 760 is different according to various communication environmental elements, such as the transmission power and the degree of proximity of the surrounding macro cells 710 and 720. Further, since the femto cell uses a lower transmission power than the macro cells 710 and 720, the service coverage of the femto cell changes more frequently than the macro cells 710 and 720.

Therefore, an exemplary embodiment of the present invention provides a method for more stably transmitting control information to a UE, that is, more stably transmitting a DCI to control a downlink in an LTE-A system through a PDCCH, in which a transmission level for transmission of the control information is determined in consideration of a service coverage of the cell supporting a service and a channel environment of a UE. Therefore, according to aspects of the present invention, in transmitting downlink control information, the DCI is transmitted using contiguous CCEs, so as to achieve a stable transmission of the control information.

Referring to FIG. 7, since the first femto cell 750 is subjected to a relatively large interference from the macro cells 710 and 720, the aggregation level of the first femto cell 750 is set to be aggregation level 4 or higher in order to transmit control information, such as a PDCCH. In contrast, since the second femto cell 760 belongs to one macro cell 710, the second femto cell 760 is subjected to a smaller interference from another cell than the first femto cell 750. Therefore, the second femto cell 760 may have a larger RF coverage than the first femto cell 750. In this network environment, since data transmission may be more exact in the second femto cell 760 than in the first femto cell 750, the aggregation level of the second femto cell 760 can be set to aggregation level 2 or higher. That is, since the second femto cell 760 is less influenced by an inter-cell interference than the first femto cell 750, the aggregation level of the second femto cell 760 can be set to be lower than that of the first femto cell 750.

The setting of the aggregation level of the second femto cell 760 to level 2 or higher implies that the DCI is repeatedly mapped to and transmitted through two contiguous CCEs. As described above, the number of generated information bits may be different according to the format of the DCI. The length of the information bits generated according to the DCI format can be increased through channel coding, and the information bits of the increased length (after being channel coded) are mapped to and transmitted by contiguous CCEs in a form of cyclic shift.

As described above, the aggregation level refers to the number of CCEs consecutively transmitted, and the aggregation level of the first femto cell 750 of FIG. 7 is set to be aggregation level 4 or higher to transmit a minimum of 4 contiguous CCEs to achieve a stable transmission of the DCI and to overcome the interference from the external network. In contrast, the aggregation level of the second femto cell 760 of FIG. 7 is set to be aggregation level 2 or higher to achieve a stable transmission of the DCI by using only 2 contiguous CCEs, which are sufficient to overcome the interference from the external network.

When the aggregation level has been set, the DCI is transmitted by a PDCCH including CCEs, the number of which is equal to or more than the corresponding aggregation level number, within a corresponding network node.

Therefore, it is possible to determine actual service coverages of femto cells and set minimum CCE aggregation levels required for transmission of the DCI for the first femto cell 750 and the second femto cell 760 so that the first femto cell 750 and second femto cell 760 can secure a stable PDCCH transmission region.

It is possible to increase the number of contiguous CCEs in a channel situation having a larger interference. The current LTE-A standards define use of 1, 2, 4, or 8 contiguous CCEs for repetitive transmission of the DCI. However, aspects of the present invention are not limited thereto, and provide efficient transmission of control information according to the surrounding network environment in order to secure a stability in transmission of control information to a UE by a system combined with a network node, such as a femto cell.

In FIG. 7, the aggregation level is set according to information of an interference from another network node. Since the aggregation level is used in order to improve the transmission efficiency of control information, the transmission accuracy of a PDCCH can be improved in consideration of various environmental elements. Now, the environmental elements will be described.

If the transmission power of a network node is low, the network node may be susceptible to an inter-cell interference, and an aggregation level of the network node may be set based on the transmission power. Even in the case of the same femto cell, if the transmission power of the femto cell changes, the aggregation level for transmission of control information may be changed to be proper for the femto cell.

Further, in the process of Inter-Cell Interference Coordination (ICIC), if the inter-cell interference is large, the aggregation level may be set to be changed. If the transmission power of a surrounding macro cell increases in a situation in which the transmission power of a femto cell is maintained, the inter-cell interference may increase. Therefore, by measuring the inter-cell interference to a femto cell, it is possible to secure the safety in transmission of the control information by raising the aggregation level if the inter-cell interference is big, and it is possible to increase the transmission efficiency of the control information by lowering the aggregation level if the inter-cell interference is small.

Meanwhile, the aggregation level may be set in consideration of the characteristics of CC, for example, in consideration of each CC or delay (propagation condition) of a used CC. The CCs may have different channel environments, based on which the lowest CCE aggregation level necessary for the DCI mapping may be determined.

If the CCs are not contiguous, the difference between characteristics of the non-contiguous CCs may be increased. Therefore, the aggregation level may be set in consideration of the network node environment according to a corresponding CC. Since an LTE-A network uses a plurality of CCs and a network node (such as femto cell) connected to the LTE-A network also uses a plurality of CCs, the aggregation level may be set in consideration of the electric wave characteristics of the CC.

In addition, various environmental parameters, which can occur in a femto cell, may be taken into consideration. For example, if the number of UEs receiving a service in a femto cell increases, an eNB may transmit more control information within a predetermined PDCCH region, which may require lowering of the aggregation level. In this case, if the control information is sent with aggregation level 8, the number of UEs capable of receiving the control information is reduced. Therefore, the eNB may determine the aggregation level in consideration of the number of all UEs within the cell.

Meanwhile, if the inter-cell interference applied to UEs within a femto cell increases, the aggregation level may be raised. A femto cell eNB determines the CCE aggregation level for transmission of CCEs in consideration of a channel condition of a UE. That is, if a channel condition of a UE is not good, a relatively high aggregation level, such as aggregation level 8, may be selected for transmission of control information from the CCE aggregation levels 1, 2, 4, and 8 for transmission of the CCE. In contrast, if a channel condition of a UE is good, the femto cell eNB may select aggregation level 1 for the transmission of control information.

Therefore, an optimum aggregation level may be determined in consideration of the number of acceptable or includable UEs and the interference between included UEs. By taking the number of UEs acceptable or includable by a femto cell and an average number of UEs receiving a service within the femto cell into consideration, it is possible to improve the efficiency of the network.

It is inefficient to unconditionally raise the lowest CCE aggregation level for a safe transmission of control information. A raise of the lowest CCE aggregation level decreases the DCI that can be mapped within a PDCCH. However, when users increase, the DCI to be transmitted increases. As a result, the quantity of data to be transmitted and received may increase to abruptly degrade the efficiency of downlink resources.

Therefore, according to an exemplary embodiment of the present invention, it is possible to improve the network efficiency by determining the transmission scheme of control information in consideration of the number of users, the stability of the network node, the coverage, or the size of the interference.

Meanwhile, as well as the interference of another network node or transmission power condition, preset information in configuring CCs by a femto cell and a macro cell of the LTE-A may be taken into consideration in setting the aggregation level. If the macro cell and the femto cell use different CCs, the femto cell can transmit a DCI through a PDCCH of non-overlapping CCs. Therefore, by lowering the aggregation level, it is possible to improve the transmission efficiency of the information.

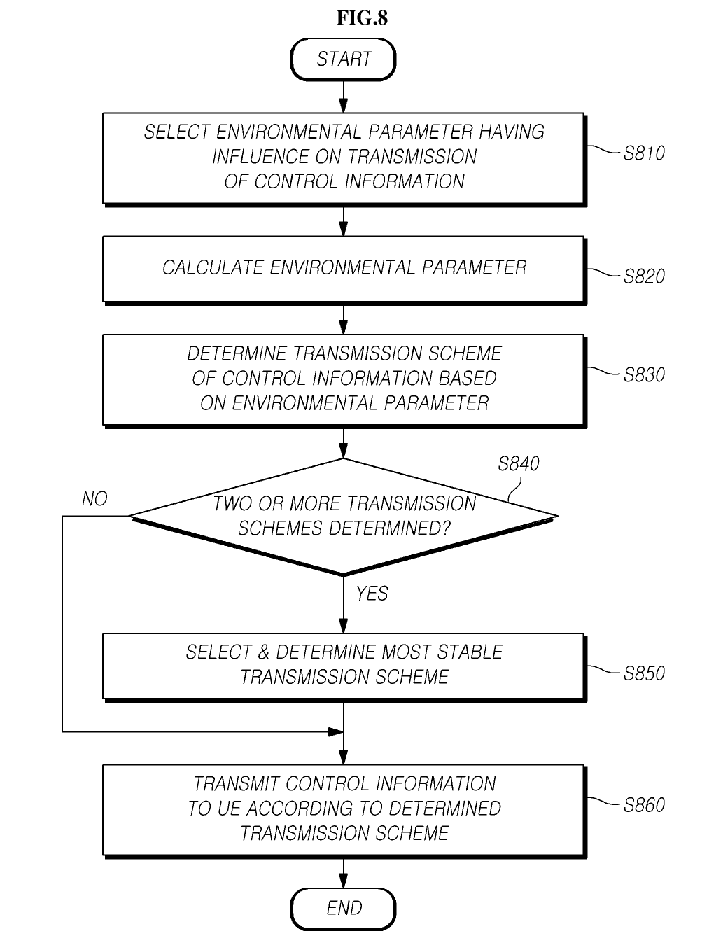

FIG. 8 is a flowchart illustrating a method for deriving a CCE aggregation level for transmission of control information according to an exemplary embodiment of the present invention. In FIG. 8, in an environment in which network nodes overlap with each other, such as a femto cell, a pico cell, or a micro cell, having a coverage smaller than that of a macro cell, determines a transmission scheme for control information and then transmits the information according to the determined scheme.

Referring to FIG. 8, a cell node identifies and selects an environmental parameter having an influence on the transmission of control information (operation S810). Selectable environmental parameters include a transmission power of a cell node, an RF service coverage of a cell, a degree of an inter-cell interference, characteristics of usable and allocatable CCs, and the maximum or average number of UEs acceptable or includable by a cell. From among the CCs usable and allocatable within a cell, characteristics of each selected CC can be taken into consideration with a larger weight.

Then, the cell node calculates the selected environmental parameter (operation S820), and determines a transmission scheme for control information according to the environmental parameter (operation S830).

For example, as shown in FIG. 7, in the case of a femto cell combined with an LTE-A system, the determination of a transmission scheme includes a determination of an aggregation level. If the environmental parameter is the transmission power of the cell node, the aggregation level can be determined through a process of measuring and calculating the transmission power. If the transmission power is high, the aggregation level can be lowered. For example, if the determined aggregation level is aggregation level 2, it can be lowered to aggregation level 1 because the sufficient high transmission power increases the reliability in receiving the control information by a UE.

If there are two or more environmental parameters for determination of the transmission scheme for control information, only one transmission scheme may be selected. In this case, among multiple transmission schemes, the most stable transmission scheme is selected and determined as the transmission scheme for the corresponding cell (operation S850).

For example, in a femto cell, either aggregation level 2 may be determined based on the transmission power or aggregation level 4 may be determined based on the inter-cell interference. In this case, aggregation level 4, which corresponds to the most stable transmission scheme, may be selected for a stable transmission of the control information. That is, an aggregation level capable of increasing the reception reliability of a UE is selected. This process is performed if it is necessary to simultaneously take various environmental parameters into consideration. However, if only one environmental parameter is taken into consideration or if one transmission scheme can be determined through a computation of multiple environmental parameters in operation S830, operations S840 and S850 can be omitted.

Further, the cell node transmits control information to a UE according to the control information transmission scheme determined in operation S830 or S850 (operation S860).

In an LTE-A system, the DCI format is determined according to the search space type, and different CCE aggregation levels may be selected according to the two types of search spaces. The two types of search spaces include a UE-specific search space (corresponding to DCI formats of 0, 1, 1A, 1B, 1D, 2, and 2A) and a common search space (corresponding to DCI formats of 1C, 3, and 3A).

The UE-specific search space corresponds to a DCI specifically transmitted to an individual UE and thus has a low importance. Therefore, in the case of the UE-specific search space, any of aggregation levels 1, 2, 4, and 8 may be selected as the CCE aggregation level.

Meanwhile, the common search space corresponds to a DCI transmitted to all UEs and thus has a high importance. Therefore, in the case of the common search space, a minimum of aggregation level 4 or 8 can be selected as the CCE aggregation level for a stable transmission.

Due to the characteristics of the two types of search spaces as described above, the cell node can determine the transmission scheme for control information based on the type of the DCI in operation S830.

Meanwhile, in operation S860, for transmitting the control information or in operations independent to operation S860, the cell node can transmit information on the transmission scheme of control information to a UE. This information can be used as reference information if the UE decodes the control information, and thus can reduce the number of times of the decoding.

For example, if the macro cell is an LTE-A cell and a network node connected to the macro cell is a femto cell, a UE can determine a valid search space and reduce the number of times for decoding of a PDCCH, based on information on a minimum CCE aggregation level of a DCI transmitted from the femto cell to the UE through the PDCCH.

Also, the transmitted information can reduce the PDCCH blind decoding complexity of the UE.

Table 1 below shows search spaces according to the PDCCH format. If the CCE aggregation level is set to level 4, only PDCCH formats 2 and 3 in Table 1 belong to a valid search space, and the UE can acquire the DCI within the PDCCH by performing blind decoding a smaller number of times. This improves the processing speed of the UE, so that the UE can more rapidly acquire the DCI within the PDCCH.

TABLE 1
Search spaces according to the PDCCH format

| | | Aggregation level | Aggregation level |
|---|---|---|---|
| | CCE aggregation | in common search | in UE-specific |
| PDCCH format | level | space | search space |
| 0 | 1 | — | 6 |
| 1 | 2 | — | 6 |
| 2 | 4 | 4 | 2 |
| 3 | 8 | 2 | 2 |

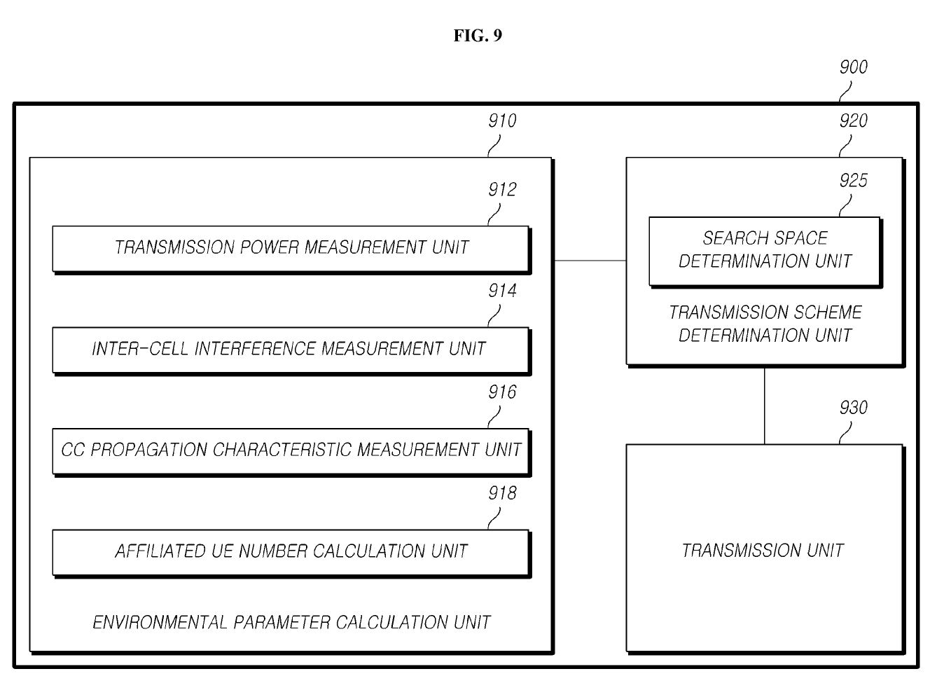

FIG. 9 is a block diagram illustrating a relation between elements for deriving a minimum CCE aggregation level in order to adjust settings of a transmission scheme of control information according to an exemplary embodiment of the present invention.

Referring to FIG. 9, the system 900 for setting a transmission scheme can be implemented within a particular cell node and corresponds to a system, such as a femto cell, a pico cell, or a micro cell, having a coverage smaller than that of a macro cell, which determines a transmission scheme for control information and then transmits the information according to the determined scheme, in an environment in which different network nodes overlap with each other.

The system 900 according to an exemplary embodiment of the present invention includes an environmental parameter calculation unit 910, a transmission scheme determination unit 920, and a transmission unit 930.

The environmental parameter calculation unit 910 can select and measure the environmental parameters having an influence on the transmission of control parameters, and the environmental parameters selectable by the environmental parameter calculation unit 910 include a transmission power of a cell node, an RF service coverage of a cell, a degree of an inter-cell interference, characteristics of usable and allocatable CCs, and the maximum or average number of UEs acceptable or includable by a cell.

For measurement and calculation of various environmental parameters, the environmental parameter calculation unit 910 includes a transmission power measurement unit 912, an inter-cell interference measurement unit 914, a CC propagation characteristic measurement unit 916, and an affiliated (or acceptable) UE number calculation unit 918. The measurement units 912, 914, 916, and 918 may calculate environmental parameters, respectively, and the environmental parameter calculation unit 910 may then collect the calculated environmental parameters. Otherwise, the environmental parameter calculation unit 910 may first collect all the measured environmental parameters and then perform a computation of one or more of the collected environmental parameters.

The transmission scheme determination unit 920 determines the transmission scheme of the control information based on a result of the computation of the environmental parameters by the environmental parameter calculation unit 910. The transmission scheme determination unit 920 may perform operation 5830 or may perform operations 5830, 5840, and S850 of FIG. 8. The transmission scheme determination unit 920 may include a search space determination unit 925 to determine the DCI format according to the search space type, and/or to select different CCE aggregation levels according to the two types of search spaces.

The two types of search spaces include a UE-specific search space (corresponding is to DCI formats of 0, 1, 1A, 1B, 1D, 2, and 2A) and a common search space (corresponding to DCI formats of 1C, 3, and 3A). The UE-specific search space corresponds to a DCI specifically transmitted to an individual UE and thus has a low importance. Therefore, in the case of the UE-specific search space, any of levels 1, 2, 4, and 8 may be selected as the CCE aggregation level. Meanwhile, the common search space corresponds to a DCI transmitted to all UEs and thus has a high importance. Therefore, in the case of the common search space, a minimum of level 4 or 8 can be selected as the CCE aggregation level for a stable transmission.

Based on the characteristics of the two search spaces, the search space determination unit 925 can determine the type of the DCI to be transmitted, and the transmission scheme determination unit 920 can determine the transmission scheme according to the type of the DCI.

The transmission unit 930 transmits the control information according to the transmission scheme determined by the transmission scheme determination unit 920. Therefore, the transmission unit 930 can repeatedly transmit the DCI through CCEs of the PDCCH, the number of which corresponds to a corresponding aggregation level of the DCI. Further, the transmission unit 930 may transmit information on the transmission scheme of control information to the UE. The transmission of information on the transmission scheme of control information can reduce the number of times of decoding by the UE, which has been described above with reference to FIG. 8 and Table 1 and will not be further described.

By establishing a transmission scheme of control information according to an exemplary embodiment of the present invention, it is possible to secure a stable PDCCH transmission region in network nodes, and it is possible to determine the degree of interference between the network nodes with reference to a preset aggregation level and use the determined degree of interference as reference information for the Inter-Cell Interference Coordination (ICIC).

For example, a femto cell may have a limited transmission power, and is thus susceptible to an inter-cell interference. Therefore, an Inter-Cell Interference Coordination (ICIC) may be necessary, and reference information or conditions, by which it is possible to objectively determine the degree of an inter-cell interference of a femto cell, may be used to apply the ICIC to the femto cell.

Since the minimum CCE aggregation level of a femto cell is information determined in consideration of various environmental parameters of the femto cell, it can be used as reference information in determining the degree of an inter-cell interference of the femto cell. Further, this information can be a parameter representing different inter-cell interference situations of the cells.

As described above with reference to FIG. 8 and FIG. 9, if a UE has received information on the transmission scheme of control information, it is possible to reduce the number of times of blind decoding of the UE.

Therefore, a UE can receive information on the transmission scheme of control information determined according to an environmental parameter having an influence on the transmission of the control information, and decode the control information according to the received information.

Also, a receiving unit of a UE can receive information on the transmission scheme of control information determined according to an environmental parameter having an influence on the transmission of the control information, and a decoding unit of the UE can decode the control information according to the received information.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A method for transmitting control information in a wireless communication network using Component Carriers (CCs), the wireless communication network comprising a first wireless communication network node and a second wireless communication network node which at least partially overlap with each other, by the second wireless communication network node, the method comprising:
selecting environmental parameters having an influence on transmission of the control information;
determining a transmission scheme of the control information according to the selected environmental parameters;
transmitting information on the transmission scheme of the control information to a User Equipment (UE) connected to the second wireless communication network node; and
transmitting the control information to the User Equipment (UE),
wherein the control information is transmitted via Physical Downlink Control Channel (PDCCH).

2. The method of claim 1, wherein the transmission scheme of the control information is determined with reference to at least one environmental parameter among the environmental parameters comprising a transmission power, usable CCs, a maximum or average number of UEs, service coverage of the second wireless communication network node, and an Inter-Cell Interference Coordination (ICIC) with the first wireless communication network node.

3. The method of claim 1, wherein the transmission scheme of the control information is determined on a different aggregation level according to a channel condition of the UE.

4. The method of claim 1, wherein the transmission scheme of the control information is determined on a different aggregation level according to a UE-specific or Common Downlink Control Information (DCI) type of the PDCCH to be used by the second wireless communication network node, the UE-specific DCI type is for the UE and the Common DCI type is for a plurality of UEs including the UE.

5. The method of claim 1, wherein the information on the transmission scheme of the control information is an aggregation level of Control Channel Elements (CCEs) determined for the UE, and the aggregation level corresponds to information on a number of times by which the control information is repeated.

6. The method of claim 1, wherein the first wireless communication network node is a macro cell and the second wireless communication network node is a femto cell, which are in a Long Term Evolution-Advanced (LTE-A) network.

7. A network node to transmit control information in a wireless communication network using Component Carriers (CCs), the wireless communication network comprising a first wireless communication network node and a second wireless communication network node, which at least partially overlap with each other, the system comprising:
an environmental parameter calculation unit to select environmental parameters having an influence on transmission of the control information;
a transmission scheme determination unit to determine a transmission scheme of the control information according to the selected environmental parameters; and
a transmission unit to transmit information on the transmission scheme of the control information and the control information to a User Equipment (UE) connected to the network node,
wherein the network node is the second wireless communication network node, and the control information is transmitted via Physical Downlink Control Channel (PDCCH).

8. The system of claim 7, wherein the transmission scheme determination unit determines the transmission scheme of the control information with reference to at least one environmental parameter among the environmental parameters comprising a transmission power, usable CCs, a maximum or average number of UEs, service coverage of the second wireless communication network node, and an Inter-Cell Interference Coordination (ICIC) with the first wireless communication network node.

9. The system of claim 7, wherein the transmission scheme determination unit determines on a different aggregation level according to a channel condition of the UE.

10. The system of claim 7, wherein the transmission scheme determination unit determines on a different aggregation level according to a UE-specific or Common Downlink Control Information (DCI) type of the PDCCH to be used by the second wireless communication network node, the UE-specific DCI type is for the UE and the Common DCI type is for a plurality of UEs including the UE.

11. The system of claim 7, wherein the transmission unit transmits the information on the transmission scheme of the control information, the information is an aggregation level of Control Channel Elements (CCEs) determined for the UE, and the aggregation level corresponds to information on a number of times by which the control information is repeated.

12. The system of claim 7, wherein the first wireless communication network node is a macro cell and the second wireless communication network node is a femto cell, which are in a Long Term Evolution-Advanced (LTE-A) network.

13. A method for receiving control information by a User Equipment (UE) in a wireless communication network using Component Carriers (CCs), the wireless communication network comprising a first wireless communication network node and a second wireless communication network node, which at least partially overlap with each other, the method comprising:
receiving information on a transmission scheme of the control information determined according to environmental parameters having an influence on transmission of the control information; and
decoding the control information based on the received information on a transmission scheme of the control information,
wherein the control information is transmitted via Physical Downlink Control Channel (PDCCH).

14. The method of claim 13, wherein the transmission scheme of the control information is determined on a different aggregation level according to a channel condition of the UE or a UE-specific or Common Downlink Control Information (DCI) type of the PDCCH to be used by the second wireless communication network node, and the information on the transmission scheme of the control information is an aggregation level of Control Channel Elements (CCEs) determined for the UE, the aggregation level corresponds to information on a number of times by which the control information is repeated.

15. A User Equipment (UE) to receive control information in a wireless communication network using Component Carriers (CCs), the wireless communication network comprising a first wireless communication network node and a second wireless communication network node, which at least partially overlap with each other, the UE comprising:
a receiving unit to receive information on a transmission scheme of the control information determined according to environmental parameters having an influence on transmission of the control information; and
a decoding unit to decode the control information based on the received information on a transmission scheme of the control information,
wherein the control information is transmitted via Physical Downlink Control Channel (PDCCH).

16. The system of claim 15, wherein the receiving unit receives that the information on the transmission scheme of the control information is an aggregation level of Control Channel Elements (CCEs) determined for the UE, the aggregation level corresponds to information on a number of times by which the control information is repeated, and the transmission scheme of the control information is determined on a different aggregation level according to a channel condition of the UE or a UE-specific or Common Downlink Control Information (DCI) type of the PDCCH to be used by the second wireless communication network node, the UE-specific DCI type is for the UE and the Common DCI type is for a plurality of UEs including the UE.

17. A method for transmitting control information in a wireless communication network using Component Carriers (CCs), the wireless communication network comprising a first wireless communication network node and a second wireless communication network node, the method comprising:
calculating environmental parameters having an influence on transmission of control information;
determining an aggregation level that corresponds to a number of contiguous Control Channel Elements (CCEs) according to the calculated environmental parameters;
allocating the control information to one or more CCEs according to the aggregation level; and
transmitting information on the aggregation level and the allocated control information to a UE connected to the second wireless communication network node.

18. The method of claim 17, wherein the control information is generated according to a Downlink Control Information (DCI) format and is allocated to the one or more CCEs in a cyclic shift form.

19. A system to transmit control information in a wireless communication network using Component Carriers (CCs), the wireless communication network comprising a first wireless communication network node and a second wireless communication network node, the system comprising:
an environmental parameter calculation unit to calculate environmental parameters having an influence on transmission of control information;
a transmission scheme determination unit to determine an aggregation level that corresponds to a number of contiguous Control Channel Elements (CCEs) according to the calculated environmental parameter; and
a transmission unit to allocate the control information to one or more CCEs according to the aggregation level, and to transmit information on the aggregation level and the allocated control information to a UE connected to the second wireless communication network node.

20. The system of claim 19, wherein the control information is generated according to a Downlink Control Information (DCI) format and is allocated to the one or more CCEs in a cyclic shift form.

21. A method for receiving control information by a User Equipment (UE) in a wireless communication network using Component Carriers (CCs), the wireless communication network comprising a first wireless communication network node and a second wireless communication network node, the method comprising:
receiving information on an aggregation level that corresponds to a number of contiguous Control Channel Elements (CCEs) and has been determined according to environmental parameters having an influence on transmission of control information;
determining a valid search space according to the received information on the aggregation level and performing a blind decoding within the valid search space; and
acquiring control information as a result of the blind decoding.

22. The method of claim 21, wherein the control information is generated according to a Downlink Control Information (DCI) format and is allocated to the one or more CCEs in a cyclic shift form.

23. A User Equipment (UE) to receive control information in a wireless communication network using Component Carriers (CCs), the wireless communication network comprising a first wireless communication network and a second wireless communication network, the UE comprising:
a receiving unit to receive information on an aggregation level that corresponds to a number of contiguous CCEs and that has been determined according to an environmental parameter having an influence on transmission of control information;
a decoding unit to determine a valid search space according to the received information on the aggregation level, to perform a blind decoding within the valid search space, and to acquire control information as a result of the blind decoding.

24. The UE of claim 23, wherein the control information is generated according to a Downlink Control Information (DCI) format and is allocated to the one or more CCEs in a cyclic shift form.

25. A method for transmitting control information by a system node in a wireless communication network using Component Carriers (CCs), the method comprising:
calculating an environmental parameter having an influence on transmission of control information;
determining a transmission scheme of the control information according to the calculated environmental parameter; and
transmitting information on a transmission scheme of the control information and the control information according to the determined transmission scheme.

26. The method of claim 25, wherein the wireless communication network comprises at least one system node of a micro cell network node, a pico cell network node, and a femto cell network node.

27. The method of claim 26, wherein the wireless communication network further comprises a Long Term Evolution-Advanced (LTE-A) network that at least partially overlaps with the at least one of the micro cell network node, the pico cell network node, and the femto cell network node with a macro cell.

28. The method of claim 25, wherein the determining the transmission scheme comprises:
determining an aggregation level that corresponds to a number of contiguous Control Channel Elements (CCEs) according to the calculated environmental parameter; and
allocating the control information to one or more CCEs according to the aggregation level.

29. A method for receiving control information by a User Equipment (UE) in a wireless communication network using Component Carriers (CCs), the method comprising:
receiving information on a transmission scheme of control information determined according to an environmental parameter having an influence on transmission of the control information; and
decoding the control information based on the received information.

30. The method of claim 29, wherein the receiving information on the transmission scheme of control information comprises:
receiving information on an aggregation level that corresponds to a number of contiguous Control Channel Elements (CCEs).

31. The method of claim 29, wherein the decoding the control information comprises:
determining a valid search space according to the received information on the aggregation level and performing a blind decoding within the valid search space; and
acquiring the control information as a result of the blind decoding.
